(19) United States
(12) Patent Application Publication
(10) Pub. No.: US 2026/0226369 A1
(43) Pub. Date: Aug. 6, 2026

(54) LAUNDRY CARE COMPOSITION

(71) Applicant: GIVAUDAN SA, VERNIER (CH)

(72) Inventors: Carlos TEIXEIRA, Sao Paulo (BR); Claudia SILVA CORTEZ PEREIRA, Sao Paulo (BR)

(21) Appl. No.: 19/150,097

(22) PCT Filed: Jan. 29, 2024
(86) PCT No.: PCT/EP2024/052028

§ 371 Date: Jul. 22, 2025

(30) Foreign Application Priority Data
Jan. 30, 2023 (GB) 2301267.7

(51) Int. Cl. C11D 3/00; C11D 3/16; C11D 3/18; C11D 3/37; C11D 3/48; C11D 3/50; C11D 11/00

(52) U.S. Cl. CPC C11D 3/0015; C11D 3/162; C11D 3/182; C11D 3/3723; C11D 3/373; C11D 3/3742; C11D 3/3773; C11D 3/48; C11D 3/50; C11D 3/505; C11D 11/0094

(57) ABSTRACT

The present invention provides a concentrated fabric softening composition, wherein the concentrated composition comprises
a) a silicone-based polymer, a C11-C15 isoparaffinic hydrocarbon or a mixture thereof;
b) a copolymer of acrylamide and cationic vinyl addition monomer; and
c) a cross-linked copolymer of acrylamide and cationic vinyl addition monomer cross-linked with a difunctional vinyl addition monomer, a method of making such a composition and the use of such a composition to provide a stable dilute fabric softener composition.

The present invention relates to concentrated fabric softening compositions, in particular to concentrated fabric softening compositions comprising a silicone and/or an isoparaffinic hydrocarbon, capable of being diluted with water in up to about 45 to 1 weight ratio of water to concentrated composition prior to use. The invention is also concerned with a method of making such a composition and to the use of the composition to provide a stable dilute fabric softener.

### BACKGROUND OF THE INVENTION

Fabric softening composition, also referred to as softeners or fabric conditioning compositions, provide benefits to treated fabrics, particularly in the last rinse phase of the automated washing process, after the washing cycle has been completed. Such benefits include fabric softening, provided by the incorporation of fabric softener actives. Fabric softening compositions are manufactured in one or more manufacturing locations before being transported and distributed to retailers and ultimately to the end users. Because typical fabric softening compositions contain a large proportion of water, it is beneficial for environmental and logistic reasons to make a concentrated premix in the manufacturing location and transport this concentrated premix to the local retailers and the end users, who can dilute the concentrated premix using tap water to make a final, dilute fabric softening composition.

In commercial liquid fabric softening compositions, the rheological properties of the product are critical for consumer acceptance. A common method of enhancing product appeal and conveying a perception of product richness and efficacy is to increase the apparent viscosity of the liquid product.

However, upon dilution with water, the viscosity of a concentrated fabric softening composition generally decreases and the rich appearance is reduced. It has been found that there are problems in meeting the viscosity requirements expected by customers for both a concentrated composition and dilute product resulting by dilution of the concentrated composition. In particular, the amount of polymer thickener required to provide sufficient viscosity in the product after dilution may result in the product having an unacceptably high viscosity prior to dilution.

There are two key requirements for pre-dilute systems:
i) the product should incorporate some mechanism which thickens the dilute product. If the initial product is too viscous, it is unlikely the product will mix satisfactorily on dilution, e.g. the diluted product may be lumpy. If the initial product has a lower viscosity such that satisfactory dispersion is assured, the resulting dilute product would usually be very thin. In many markets consumers have been encouraged to associate high viscosity with product strength; and
ii) after dilution, the resulting product must exhibit good viscostability and stability with respect to phase separation, as the product will be kept for some time and be used over a good number of washes/rinses.

Cationic linear and cross-linked polymers are well-known in the art as ingredients that provide apparent viscosity in fabric softening compositions.

For example, WO2004/061065 and WO2004/061066 disclose stable concentrated aqueous fabric softening compositions which are capable of being diluted with water in a 4 to 1 weight ratio of water to concentrated softening composition prior to use, comprising at least one cationic fabric softener and mixtures of cationic polymers capable of modifying the rheological properties of such softener compositions.

WO2007/141310 discloses a concentrated aqueous fabric softening composition which is capable of being diluted with water in a 3 to 1 weight ratio of water to softening composition, the composition comprising a mixture of a cationic fabric softener, a cationic cross-linked polymer; and an electrolyte, such as CaCl₂).

While the use of polymeric thickeners to enhance consumer appeal is known in the prior art, there remains a need for concentrated liquid fabric softeners which are physically stable and flowable, and which can be diluted with water in the order of up to 45 to 1 for use in the rinse cycle, while remaining physically stable and readily pourable as a diluted composition. The concentrated fabric conditioning composition must be stable, fragranced, preserved and with appropriate rheological profile such that it performs in a manner expected, in particular as regards an appropriate aspect and viscosity during and after dilution by the consumer. It is further highly important that the diluted product is also visually attractive and functionally adequate.

Despite the prior art there remains a need for improved concentrated liquid fabric softeners which can be diluted by the user to form a working composition. Typically, such compositions are purchased by the consumer and diluted in the domestic environment. The environmental and logistics benefit increases with the dilution factor of the concentrated fabric conditioning composition. Therefore, there is a need to provide concentrated fabric softening compositions which are capable of being diluted with water in up to about a 45 to 1 weight ratio of water to concentrated softening composition prior to use as laundry softener in a rinse cycle.

### SUMMARY OF THE INVENTION

In one aspect, the present invention provides a concentrated fabric softening composition, wherein the concentrated composition comprises
a) a silicone-based polymer, a C11-C15 isoparaffinic hydrocarbon or a mixture thereof;
b) a copolymer of acrylamide and cationic vinyl addition monomer; and
c) a cross-linked copolymer of acrylamide and cationic vinyl addition monomer cross-linked with a difunctional vinyl addition monomer.

In another aspect, the invention relates to a method of making a concentrated fabric softening composition as defined herein.

In another aspect, the use of a concentrated fabric softening composition as defined herein to generate a diluted liquid fabric softener is provided.

### Definitions

A concentrated fabric softening composition refers to a composition suitable to be diluted to a liquid fabric softener capable of softening fabrics, e.g., clothing in a domestic washing machine.

A liquid fabric softener refers to any treatment composition comprising a liquid capable of softening fabrics, e.g., clothing in a domestic washing machine.

Quaternary ammonium compounds (QAC) are salts of quaternary ammonium cations. Quaternary ammonium cations, also known as quats, are positively charged polyatomic ions of the structure NR₄⁺, R being an alkyl group or an aryl group. Unlike the ammonium ion (NH₄⁺) and the primary, secondary, or tertiary ammonium cations, the quaternary ammonium cations are permanently charged, independent of the pH of their solution. As referred to herein, the quaternary ammonium compounds are not polymeric. Typical quaternary ammonium compounds used in fabric softening compositions include so-called esterquats.

By “physically stable” composition it is meant that the composition does not separate into different phases upon aging for typically 3 months to 1 year.

All percentages and ratios are calculated by weight unless otherwise indicated.

The term “perfume” or “fragrance” as used herein refers to odoriferous materials which are able to provide a pleasing fragrance to fabrics, and encompasses conventional materials commonly used in laundry care compositions to counteract a malodor in such compositions and/or provide a pleasing fragrance thereto.

### DETAILED DESCRIPTION

Preferred and/or optional features of the invention will now be set out. Any aspect of the invention may be combined with any other aspect of the invention unless the context demands otherwise. Any of the preferred or optional features of any aspect may be combined, singly or in combination, with any aspect of the invention, as well as with any other preferred or optional features, unless the context demands otherwise.

The applicant has surprisingly and unexpectedly found that the combination of
a) a silicone-based polymer, a C11-C15 isoparaffinic hydrocarbon or a mixture thereof;
b) a copolymer of acrylamide and cationic vinyl addition monomer; and
c) a cross-linked copolymer of acrylamide and cationic vinyl addition monomer cross-linked with a difunctional vinyl addition monomer
   provides a concentrated composition which is capable of being diluted with water in up to about a 45 to 1 weight ratio of water to concentrated composition such that both the concentrated composition and the resulting diluted fabric softener are physically stable and have viscosities that are acceptable to the customers.

The present invention is based on the discovery that the use of a mixture of a cationic copolymer; a cross-linked copolymer; and a silicone-based polymer and/or a C11-C15 isoparaffinic hydrocarbon as defined herein in a concentrated fabric softening composition allows the viscosity of both the concentrated composition and the diluted “ready-to-use” fabric softener to be regulated so as to achieve the desired flow properties of thickness and ease of pourability.

Furthermore, the fabric softening composition of the present invention is preferably free of quaternary ammonium compounds, as well as of any other low-molecular cationic, anionic and non-ionic surfactants. This is an advantage in case fragrance-containing microcapsules are added to the fabric conditioning composition, as it is known that the stability of such microcapsules with respect to leakage may be affected by the presence of such surfactants.

### Silicone-Based Polymer

The concentrated fabric softening composition of the present invention comprises a silicone-based polymer as a fabric softening active.

Silicone-based polymers suitable as being used in the present invention can be any silicone comprising polymer. The silicone comprising polymer may be selected from the group consisting of cyclic silicones, polydimethylsiloxanes, aminosilicones, cationic silicones, silicone polyethers, silicone resins, silicone urethanes, and combinations thereof. The silicone may be a polydialkylsilicone, alternatively a polydimethyl silicone (polydimethyl siloxane or “PDMS”, or dimethicone), or a derivative thereof. The silicone may be chosen from an aminofunctional silicone, amino-polyether silicone, alkyloxylated silicone, cationic silicone, ethoxylated silicone, propoxylated silicone, ethoxylated/propoxylated silicone, quaternary silicone, or combinations thereof.

In one embodiment, the silicone-based polymer is polydimethyl siloxane (PDMS). In one embodiment, the silicone-based polymer is decamethyltetrasiloxane. In one embodiment, the silicone-based polymer is dimethicone base fluid sold under the trade name XIAMETER™ PMX-200 Silicone Fluid (Dow), which shows high hydrophobicity and excellent spreadability, among other benefits. In one embodiment, the silicone-based polymer is decamethyltetrasiloxane base fluid sold under the trade name XIAMETER™ PMX-200 Silicone Fluid 1.5 cSt, which shows a kinematic viscosity of 1.5 cSt. In one embodiment, the silicone-based polymer is decamethyltetrasiloxane base fluid sold under the trade name XIAMETER™ PMX-200 Silicone Fluid 2 cSt, which shows a kinematic viscosity of 2 cSt. The later polymer has the advantage of higher safety in the manufacturing process of the laundry composition.

In one embodiment, the silicone-based polymer is dimethicone base fluid sold under the trade name XIAMETER™-MEM-2664-emulsion (Dow).

In one embodiment, the silicone-based polymer is cyclopentasiloxane sold under the trade name XIAMETER™ PMX-0245 (Dow).

In one embodiment, the silicone-based polymer is an amino-silicone, such as amodimethicone. In one embodiment, the amino-silicone is sold under the trade name DOWSIL™ 2-8566 Amino Fluid (Dow). In one embodiment, the amino-silicone is sold under the trade name DOWSIL™ FM-6620 Emulsion (Dow).

In one embodiment, the silicone-based polymer is a mixture of cyclopentasiloxane and an amino-silicone, such as amodimethicone. In one embodiment, the ratio between the cyclopentasiloxane and the amodimethicone is between about 2.5:1 to about 3:1, optionally about 2.7:1.

### C11-C15 Isoparaffinic Hydrocarbon

Isoparaffinic hydrocarbons are synthetic isoalkane mixtures produced by a hydrogenation treatment of a petroleum distillate (naptha) fraction in the presence of a catalyst. C11-C15 isoparaffinic hydrocarbons are mixtures of hydrocarbons having carbon numbers in range C11 to C15 and comprise mainly branched alkanes (isoalkanes or isoparrafins).

In one embodiment, the C11-C15 isoparaffinic hydrocarbon is sold under the trade name ISOPAR™ L FLUID (Exxon Mobil).

In one embodiment, a mixture of C11-C15 isoparaffinic hydrocarbon and a silicone-based polymer such as amodimethicone is employed. In one embodiment, the ratio between the C11-C15 isoparaffinic hydrocarbon to amodimethicone is between about 0.5:1 to about 2:1, optionally about 1:1.

In one embodiment, the silicone-based polymer and/or the C11-C15 isoparaffinic hydrocarbon is present in an amount of between about 5 wt % and about 30 wt %, preferably between about 8 wt % and about 26 wt % of the concentrated fabric softening composition, still more preferably between about 12 wt % and about 15 wt %, preferably 13 wt % of the concentrated fabric softening.

### Cationic Polymers

The fabric softening composition of the present invention comprises cationic polymers, more particularly cationic copolymers. Such polymers include polyquaterniums, as additional softening actives. The term polyquaternium is the International Nomenclature for Cosmetic Ingredients (INCI) designation for various polycationic polymers, including Polyquaternium 1-47.

Those of ordinary skill in the art will recognize that many of these cationic agents serve multiple functions. Typically, these agents are useful as conditioners, antistatic agents, fabric softening, and as antimicrobial agents.

Cationic acrylamide copolymers have been used as viscosity or rheology control agents. Examples of such commercially available copolymers are Polyquaternium 15 and Polyquaternium 32.

The concentrated fabric softening composition of the present invention comprises a combination of cationic polymers.

In preferred embodiments, the composition of the invention comprises a combination of a copolymer of acrylamide and cationic vinyl addition monomer and a cross-linked copolymer of acrylamide and cationic vinyl addition monomer cross-linked with a difunctional vinyl addition monomer.

### Copolymer of Acrylamide and Cationic Vinyl Addition Monomer

In the present invention, the first cationically charged polymer is a copolymer of acrylamide and cationic vinyl addition monomer, such as poly(diallyldimethylammonium chloride-co-acrylamide) copolymer (e.g. Polyquaternium 7).

In one embodiment, the cationically charged polymer is a copolymer of acrylamide and diallyldimethylammonium chloride sold under the tradename Flosoft LS407 from SNF Floerger.

In one embodiment, the copolymer of acrylamide and diallyldimethylammonium chloride is present in an amount of between about 1 wt % and about 10 wt %, preferably between about 3 wt.-% and about 5 wt %, still more preferably about 3.5 and about 4.5 wt.-% of the concentrated fabric softening composition.

Cross-Linked Copolymer of Acrylamide and Cationic Vinyl Addition Monomer Cross-Linked with a Difunctional Vinyl Addition Monomer

In the present invention, the second cationic acrylamide copolymer is a cross-linked copolymer of acrylamide and cationic vinyl addition monomer cross-linked with a difunctional vinyl addition monomer.

In one embodiment, the second cationic polymer is a cross-linked copolymer derivable from the polymerization of from 5 to 100 mol percent of cationic vinyl addition monomer, from 0 to 95 mol percent of acrylamide and from 50 to 1000 ppm of a difunctional vinyl addition monomer cross-linking agent.

In one embodiment, the difunctional vinyl addition monomer is methylene bisacrylamide.

In one embodiment, the cationic cross-linked copolymer is a result of copolymerization of about 20% acrylamide, about 80% MADAM methyl chloride (MADAM is dimethyl amino ethyl methacrylate) cross-linked with from 450 to 600 ppm of methylene bisacrylamide. The resulting polymer may be referred to as poly(trimethylammonioethylmethacrylate chloride-co-acrylamide) copolymer (e.g. Polyquaternium-15), cross-linked with methylene bisacrylamide. Such materials are commercially available from SNF Floerger under the trade name Flosoft FS 222. In one embodiment, the cross-linked copolymer of acrylamide and cationic vinyl addition monomer cross-linked with a difunctional vinyl addition monomer is present in an amount of between about 5 wt % and about 25 wt %, preferably between about 12 wt % and about 20 wt %, still more preferably between about 15 wt % and 17 wt.-% of the concentrated fabric softening composition.

Without wishing to be bound by theory, it is believed that the combination of a silicone-based polymer and/or C11-C15 isoparaffinic hydrocarbon; a copolymer of acrylamide and cationic vinyl addition monomer; and a cross-linked copolymer of acrylamide and cationic vinyl addition monomer cross-linked with a difunctional vinyl addition monomer provides the desired viscosity profile for the concentrated fabric softening composition according to the invention, at the same time providing the desired viscosity profile for the diluted aqueous laundry softener, at a dilution factor of up to 45 to 1.

In one embodiment, the viscosity of the concentrated fabric softening composition according to the invention is between about 50 cps to about 3000 cps, optionally between about 100 cps to about 2900 cps, optionally between 200 cps to about 2800 cps.

In one embodiment, the total amount of softener actives, e.g. the silicone-based polymer and/or C11-C15 isoparaffinic hydrocarbon, the copolymer of acrylamide and cationic vinyl addition monomer and the cross-linked copolymer of acrylamide and cationic vinyl addition monomer cross-linked with a difunctional vinyl addition monomer, is between about 20 wt % and 50 w %, preferably between about 25 wt % and about 40 wt %, still more preferably between about 27 wt % and about 34 wt %.

In one embodiment, the viscosity of the aqueous fabric softener after dilution in a ratio of up to 45 to 1 water to concentrated composition is between about 100 cps to about 3000 cps, optionally between about 200 cps to about 1200 cps, optionally between about 300 cps to about 1100 cps.

Viscosities are measured on a Brookfield RV DV at 50 RPM, spindle SC4-28 at 25° C. for all measurements.

Concomitantly and surprisingly, the fabric conditioning composition retains its ability to soften fabrics upon dilution up to a dilution factor of 45:1.

### Non-Encapsulated Fragrance Ingredient

In one embodiment, the concentrated fabric softening composition comprises at least one non-encapsulated fragrance ingredient. A comprehensive list of fragrance ingredients that may be present in the composition in accordance with the present invention may be found in the perfumery literature, for example “Perfume & Flavor Chemicals”, S. Arctander (Allured Publishing, 1994). The at least one non-encapsulated fragrance ingredient may be a fragrance ingredient characterized by having a boiling point higher than 250° C.

The at least one non-encapsulated fragrance ingredient may be present in an amount of between about 5 wt % to about 20 wt %, more particularly between about 8 wt % to about 15 wt.-%, optionally about 8.8 wt % or about 13.2 wt % of the concentrated fabric softening composition.

### Microcapsule Composition

In one embodiment, the concentrated fabric softening composition comprises a microcapsule composition comprising a polymer encapsulating a benefit agent, wherein the benefit agent is encapsulated in core-shell microcapsules comprising a core and a shell surrounding the core.

Core-shell microcapsule compositions are generally provided in the form of a slurry, that is, a dispersion or suspension of microcapsules in an aqueous medium, that may contain somewhere in the order of 60 wt.-% of water. If desired, slurries can be dried to provide microcapsule compositions in the form of a powder or cake, which generally comprises around 5 wt.-% of water.

In one embodiment, the shell of the core-shell microcapsules comprises a polymer selected from the group consisting of a melamine-formaldehyde polymer, a urea-formaldehyde polymer, a polyurea, a polyurethane, a polyamide, a polyacrylate, a polycarbonate, and mixtures thereof, as defined hereinabove.

### Thermosetting Resins

Thermosetting resins are typically obtained by reacting polyfunctional monomers, such as amines, isocyanates, alcohols or phenols, chlorocarboxylic acids, (meth)acrylates, epoxides, silanes and aldehydes.

Thermosetting resins, such as aminoplast, polyurea and polyurethane resins, as well as combinations thereof are commonly employed as shell materials in the preparation of core-shell microcapsules. They are particularly valued for their resistance to leakage of the benefit agent when dispersed in aqueous suspending media, even in surfactant-containing media.

In one embodiment, the shell may comprise a melamine-formaldehyde polymer. This type of core-shell capsule has proved to be particularly suitable for benefit agent encapsulation and is described, for instance in WO 2008/098387 A1, WO 2016/207180 A1 and WO 2017/001672 A1.

In one embodiment, the shell may comprise a polyurea or polyurethane polymer. Also this type of core-shell capsule has been successfully used for benefit agent encapsulation and has the advantage to address consumer concerns with regard to residual formaldehyde in the composition. Such capsules are also described, for instance in WO 2019/174978 A1.

In one embodiment, the shell may comprise, a polyacrylate, one or more monoethylenically unsaturated and/or polyethylenically unsaturated monomer(s) in polymerized form. This type of core-shell capsule has also been successfully used for benefit agent encapsulation. Such capsules are described in the prior art, for instance in WO 2013/111912 A1 or WO 2014/032920 A1.

### Polymeric Stabiliser

In one embodiment, the shell may comprise a polymeric stabilizer that is formed by combination of a polymeric surfactant with at least one aminosilane. The polymeric surfactant comprises a polysaccharide comprising carboxylic acid groups. The aminosilane is as defined hereinbelow. The shell may further comprise a polysaccharide, preferably a polysaccharide comprising beta (1→4) linked monosaccharide units, even more preferably a cellulose derivative, in particular selected form the group consisting of hydroxyethyl cellulose, hydroxypropylmethyl cellulose, cellulose acetate, carboxymethyl cellulose, and combinations thereof, preferably hydroxyethyl cellulose. Such capsules are described in the prior art, for instance in WO 2020/233887A1.

### Hydrated Polymer Phase and Polymeric Stabilizer

In one embodiment, the shell may comprise a hydrated polymer phase and a polymeric stabilizer at an interface between the shell and the core.

In such an arrangement, the polymeric stabilizer provides an impervious encapsulating material, whereas the hydrated polymer phase provides the desired deposition and adherence to the substrate. Furthermore, without being bound by any theory, it is surmised that the hydrated polymer phase also provides an optimal point of attack for microbial degradation.

The polymeric stabilizer may be selected from a broad range of film-forming materials and resins. Preferably, the polymeric stabilizer is highly cross-linked, in order to decrease significantly the diffusion of the encapsulated benefit agent through the shell. Preferably the imperviousness of the shell is sufficiently high to significantly prevent the leakage of the benefit agent in extractive base, such as consumer products comprising surfactants.

In one embodiment of the present invention, the polymeric stabilizer is a thermosetting resin.

Thermosetting resins are typically obtained by reacting polyfunctional monomers, such as amines, isocyanates, alcohols or phenols, chlorocarboxylic acids, (meth)acrylates, epoxides, silanes and aldehydes.

In one embodiment of the present invention, the polymeric stabilizer is formed by reaction of an aminosilane with a polyfunctional isocyanate. Such a polymeric stabilizer has the advantage of being highly crosslinked and susceptible of providing surface anchoring groups that can be used to immobilize additional materials to complete shell formation. These additional materials may comprise additional encapsulating materials, coatings and, as described in more details hereinafter, simple and complex coacervate, and hydrogels.

The aminosilane employed in the formation of the polymeric stabilizer can be selected from a compound of Formula (I).

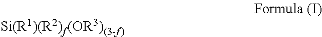

wherein R¹ is a linear or branched alkyl or alkenyl residue comprising an amine functional group; R² is each independently a linear or branched alkyl group with 1 to 4 carbon atoms; R³ is each independently a H or a linear or branched alkyl group with 1 to 4 carbon atoms; and f is 0, 1 or 2.

The silane groups may undergo polycondensation reactions with one another to form a silica network at the oil/water interface that additionally stabilizes this interface.

In one embodiment, R² and R³ are each independently methyl or ethyl.

In one embodiment, f is 0 or 1.

In one embodiment, R¹ is a C₁-C₁₂ linear or branched alkyl or alkenyl residue comprising an amine functional group. Optionally, R¹ is a C₁-C₄ linear or branched alkyl or alkenyl residue comprising an amine functional group.

In one embodiment, the amine functional group is a primary, a secondary or a tertiary amine.

In one embodiment, the at least one aminosilane is a bipodal aminosilane. By “bipodal aminosilane” it is meant a molecule comprising at least one amino group and two residues, each of these residues bearing at least one alkoxysilane moiety. Bipodal aminosilanes are particularly advantageous for forming stable oil-water interfaces, compared to conventional aminosilanes. Without wishing to be bound by theory, it is believed that this beneficial role is due to the particular, bi-directional arrangement of the silane moieties in the molecule of a bipodal aminosilane, which allows formation of a more tightly linked silica network at the oil-water interface.

In one embodiment, the bipodal aminosilane is a compound of Formula (II).

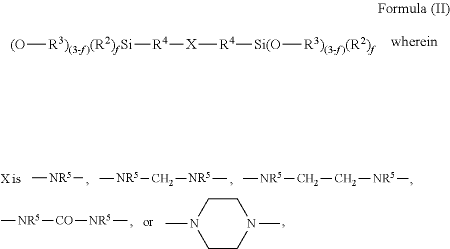

R² is each independently a linear or branched alkyl group with 1 to 4 carbon atoms;
R³ is each independently H or a linear or branched alkyl group with 1 to 4 carbon atoms;
R⁴ is each independently a linear or branched alkylene group with 1 to 6 carbon atoms;
R⁵ is each independently H, CH₃ or C₂H₅; and
f is each independently 0, 1 or 2.

In one embodiment, R² is CH₃ or C₂H₅.

In one embodiment, R³ is CH₃ or C₂H₅.

In one embodiment, R⁴ is —CH₂—, —CH₂—CH₂— or —CH₂—CH₂—CH₂—.

In one embodiment, R⁵ is H or CH₃.

In one embodiment, f is 0 or 1.

Examples of suitable bipodal aminosilanes include, but are not limited to, bis(3-(triethoxysilyl)propyl)amine, N,N′-bis(3-(trimethoxysilyl)propyl)urea, bis(3-(methyldiethoxysilyl) propyl)amine, N,N′-bis(3-(trimethoxysilyl)propyl) ethane-1,2-diamine, bis(3-(methyldimethoxysilyl)propyl)-N-methylamine, N,N′-bis(3-(triethoxysilyl)propyl) piperazine, and combinations thereof.

In one embodiment, the bipodal aminosilane is bis(3-(triethoxysilyl)propyl)amine, which has the advantage of releasing ethanol instead of more toxic and less desirable methanol during the polycondensation of the ethoxysilane groups.

The bipodal aminosilane can be a secondary aminosilane. Using a secondary bipodal aminosilane instead of a primary aminosilane decreases the reactivity of the polymeric stabilizer with respect to electrophilic species, in particular aldehydes. Hence, benefit agents containing high levels of aldehydes may be encapsulated with a lower propensity for adverse interactions between core-forming and shell-forming materials.

Other aminosilanes may also be used in combination with the aforementioned bipodal aminosilanes, in particular the aminosilanes described hereinabove.

The polyfunctional isocyanate may be selected from organic isocyanates, in which an isocyanate group is bonded to an organic residue (R—N═C═O or R—NCO). The polyfunctional isocyanate may be selected from alkyl, alicyclic, aromatic and alkylaromatic, as well as anionically modified polyfunctional isocyanates, with two or more (e.g. 3, 4, 5, etc.) isocyanate groups in a molecule, and mixtures thereof.

Preferably, the polyfunctional isocyanate is an aromatic or an alkylaromatic isocyanate, the alkylaromatic polyfunctional isocyanate having preferably methylisocyanate groups attached to an aromatic ring. Both aromatic and methylisocyanate-substituted aromatic polyfunctional isocyanates have a superior reactivity compared to alkyl and alicyclic polyfunctional isocyanates. Among these, 2-ethylpropane-1,2,3-triyl tris((3-(isocyanatomethyl)phenyl)carbamate) is particularly preferred, because of its trifunctional nature that favors the formation of intermolecular cross-links and because of its intermediate reactivity that favors network homogeneity. This alkylaromatic polyfunctional isocyanate is commercially available under the trademark Takenate D-100 N, sold by Mitsui or under the trademark Desmodur® Quix175, sold by Covestro.

As an alternative to aromatic or alkylaromatic polyfunctional isocyanates, it may also be advantageous to add an anionically modified polyfunctional isocyanates, because of the ability of such polyfunctional isocyanates to react at the oil/water interface and even in the water phase close to the oil/water interface. A particularly suitable anionically modified polyfunctional isocyanate has Formula (III).

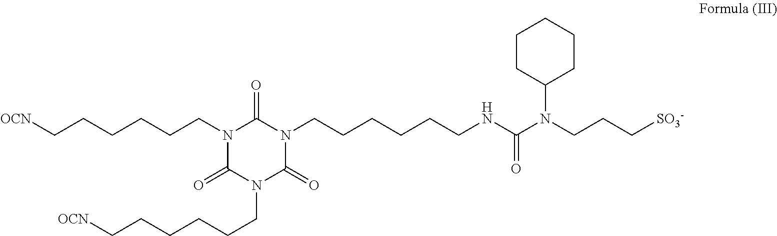

Formula (III) shows a commercially available anionically modified polyisocyanate, which is a modified isocyanurate of hexamethylene diisocyanate, sold by Covestro under the trademark Bayhydur® XP2547.

In a preferred embodiment of the present invention, polyfunctional isocyanate is 2-ethylpropane-1,2,3-triyl tris((3-(isocyanatomethyl)phenyl)carbamate). Particularly preferably, the polymeric stabilizer is formed by reaction of bis(3-(triethoxysilyl)propyl)amine and 2-ethylpropane-1,2,3-triyl tris((3-(isocyanatomethyl)phenyl)carbamate). The combination of this particular bipodal secondary aminosilane and polyfunctional isocyanate provides advantageous interface stability and release properties. The stabilized interface is sufficiently impervious to effectively encapsulate the at least one benefit agent comprised in the core and possesses the desired surface functional groups.

In preferred embodiments of the present invention the hydrated polymer phase can be a coacervate, in particular a complex coacervate.

By “complex coacervation” is meant the formation of an interfacial layer comprising a mixture of polyelectrolytes.

The phenomenon of coacervation may be observed under a light microscope, wherein it is marked by the appearance of a ring around the core composition droplet. This ring consists of the aforementioned polyelectrolyte-rich phase that has a different refractive index than the surrounding aqueous phase.

The coacervation of a polyelectrolyte is generally induced by bringing the polyelectrolyte to its isoelectric point, meaning the point where the net charge of the polyelectrolyte is zero or close to zero. This may be achieved by changing the salt concentration or the pH of the medium. In a complex coacervation, complexation occurs at the pH where one of the polyelectrolytes has an overall positive electrical charge (polycation), whereas the other polyelectrolyte has an overall negative charge (polyanion), so that the overall electrical charge of the complex is neutral.

In preferred embodiments of the present invention, the coacervate may be formed from a polycation and a polyanion.

Preferably, the pH is used as parameter driving the coacervation. Thus, the polycation preferably has a pH-dependent electrical charge. This is the case for polymers bearing primary, secondary and tertiary amino groups, such as polyamines, for example chitosan, and most proteins, for example gelatin. Proteins have the additional advantage of being prone to temperature-dependent structural transitions that may also be used to control the morphology of the coacervates. In particular, varying the temperature of some proteins may induce the formation of secondary, tertiary or quaternary structures of the protein that may also be used to control the properties of the coacervate.

Chitosan has the advantage of being derived from chitin, which is a natural polymer.

In preferred embodiments of the present invention, the polycation is selected from the group consisting of proteins, chitosan, and combinations thereof.

More particularly, the polycation can be a protein selected from the group consisting of gelatin, casein, albumin, polylysine, soy proteins, pea proteins, rice proteins, hemp proteins, and combinations thereof.

In particularly preferred embodiments of the present invention, the at least one protein is a gelatin, even more preferably a Type B gelatin.

Type B gelatin can be obtained from the alkaline treatment of collagen and is well known for its ability to form complexes with anionic polyelectrolytes, such as negatively charged polysaccharides under mild acidic conditions.

Gelatin is usually characterized by the so-called “Bloom Strength”. In the context of the present invention, the Bloom Strength refers to the rigidity of a gelatin film, as measured by so-called “Bloom Gelometer”, according to the Official Procedures of the Gelatin Manufacturers Institute of America, Inc., revised 2019, Chapter 2.1. According to this procedure, the Bloom Strength, expressed in Bloom, is equal to the weight, expressed in g, required to move vertically a standardized plunger, having a diameter of 12.5 mm, to a depth of 4 mm into a gelatin gel, which has been prepared under controlled conditions, i.e. by dissolving 6.67 wt.-% of gelatin in deionized water at 60° C., in a standardized jar, and letting the gel form for 17 hours at 10° C. The higher the weight is, the higher is the Bloom Strength of the gelatin used for making the tested gel.

In preferred embodiments of the present invention, the Type B gelatin has a Bloom Strength of 90 to 250 Bloom.

If the Bloom Strength is too low, the gel is mechanically weak and coacervates obtained therefrom may not form a self-standing layer of gelatin-rich phase around the core composition.

If the Bloom Strength is too high, then the coacervates and the gelatin-rich phase obtained therefrom may be too brittle.

In preferred embodiments of the present invention, the Type B gelatin is obtainable from fish, because fish gelatin meets better acceptance within consumer than beef or pork gelatin, mainly due to health concerns, sociological context or religious rules.

Alternatively, the protein may be a vegetable protein, in particular a pea protein and/or a soy protein, which have the advantage of being vegan.

The polycation may be a denaturated protein. In the contrary to native proteins, denaturated proteins have been deprived from their ability to form secondary, tertiary or quaternary structures and are essentially amorphous. Such amorphous proteins may form more impervious films compared to native proteins and therefore also contribute to the encapsulating power of the shell. Denaturation may be achieved by treating the protein with chemical or physical means, such as acid or alkaline treatment, heat or exposure to hydrogen bond disrupting agents.

In cases where the polycation is chitosan, the chitosan can have a molecular weight between 3′000 and 1′000′000 g/mol, more particularly between 10′000 and 500′000 g/mol, still more particularly between 30′000 and 300′000 g/mol.

The polyanion may be any negatively charged polymer. However, as the pH is preferably used to control coacervation, it may be more advantageous that the electrical charge of the polymer is pH-dependent. Such polymer may be selected from polymers having pendent carboxylic groups, such as methacrylic acid and acrylic acid polymers and copolymers, hydrolyzed maleic anhydride copolymers and polysaccharides bearing carboxylic groups.

In preferred embodiments of the present invention, the polyanion is a polysaccharide comprising carboxylate groups and/or sulfate groups.

Polysaccharides comprising carboxylate groups are particularly suitable for complex coacervation with proteins. This is due to the fact that the net electrical charge of these polysaccharides may be adjusted by adjusting the pH, so that the complexation with ampholytic proteins is facilitated. Complexation occurs at the pH where the protein has an overall positive electrical charge, whereas the polysaccharide as an overall negative charge, so that the overall electrical charge of the complex is neutral. These polysaccharides include native polysaccharides, i.e. unmodified from nature, and modified polysaccharides.

The polysaccharide comprising carboxylic acid groups may comprise uronic acid units, in particular hexuronic acid units. Such polysaccharides are broadly available in nature.

The hexuronic acid units can be selected from the group consisting of galacturonic acid units, glucuronic acid units, in particular 4-O-methyl-glucuronic acid units, guluronic acid units, mannuronic acid units, and combinations thereof.

The polysaccharide comprising carboxylic acid groups may be branched. Branched polysaccharides comprising carboxylic acid groups have the advantage of forming more compact networks than linear polysaccharides and therefore may favor the imperviousness of the encapsulating shell, resulting in reduced leakage and greater encapsulation efficiency.

The carboxylate groups can be at least partially present in the form of the corresponding carboxylate salt, in particular the corresponding sodium, potassium, magnesium or calcium carboxylate salt.

In particular embodiments of the present invention, the polyanion is selected from the group consisting of pectin, gum arabic, alginate, and combinations thereof.

Among the pectins, the carboxylic acid groups can be partially present in the form of the corresponding methyl ester. The percentage of carboxylic acid groups that are present in the form of the corresponding methyl ester can be from 3% to 95%, preferably from 4% to 75%, more preferably from 5 to 50%. Pectins comprising carboxylic groups, of which 50% or more are present in the form of the corresponding methyl ester, are referred to as “high methoxylated”. Pectins comprising carboxylic acid groups, of which less than 50% are present in the form of the corresponding methyl ester, are referred to as “low methoxylated”.

Among the two variants of gum Arabic, i.e. gum acacia Senegal and gum acacia Seyal, gum acacia Senegal is preferred, owing to the higher level of glucuronic acid in gum acacia Senegal.

The hydrated polymer phase can be a hydrogel.

In context of the present invention, a “hydrogel” is a three-dimensional (3D) network of hydrophilic polymers that can swell in water, while maintaining the structure due to chemical or physical cross-linking of individual polymer chains.

Such a hydrogel can be formed by several methods at interfaces, especially by self-assembly of polyelectrolytes around existing interfaces, covalent grafting of pre-formed hydrogel particles in solution, polymerization of hydrosoluble monomers initiated at the interface and phase separation of water soluble macromolecules onto the interface.

To avoid any ambiguity, in context of the present invention, a coacervate, especially a complex coacervate, which is cross-liked, in particular by covalent bonds, is considered as a hydrogel.

The applicant has found that the use of hydrogels particularly enhances both the deposition and adherence of microcapsules on substrates, in particular on fabrics.

The hydrogel can be interlinked with the polymeric stabilizer, in particular via the functional groups present on the surface of this stabilizer.

This allows the locking of the hydrogel layer onto the polymeric stabilizer present at droplet interface, making the shell composed of a polymer composite, instead of only a blend.

Both hydrogel cross-linking and hydrogel interlinking with the polymeric stabilizer may be performed sequentially or simultaneously.

In preferred embodiments of the present invention, the hydrogel is a crosslinked coacervate, in particular a complex coacervate crosslinked with polyfunctional aldehyde, more particularly a difunctional aldehyde selected from the group consisting of succinaldehyde, glutaraldehyde, glyoxal, benzene-1,2-dialdehyde, benzene-1,3-dialdehyde, benzene-1,4-dialdehyde, piperazine-N, N-dialdehyde, 2,2′-bipyridyl-5,5′-dialdehyde, and combinations thereof. Difunctional aldehydes are known to be effective cross-linking agents for proteins.

The hydrogel can be thermosensitive and possess a gelation temperature, in particular between 20° C. and 50° C., preferably between 25° C. and 40° C. When using such a hydrogel, the deposition performance of the capsules on fabic can increase, when washing the fabric at a temperature which is above hydrogel gelation temperature.

The shell can be further stabilized with a stabilizing agent. Preferably the stabilizing agent comprises at least two carboxylic acid groups. Even more preferably, the stabilizing agent is selected from the group consisting of citric acid, benzene-1,3,5-tricarboxylic acid, benzene-1,2,4-tricarboxylic acid, 2,5-furandicarboxylic acid, itaconic acid, poly(itaconic acid) and combinations thereof.

### Coacervates

In one embodiment, the shell can comprise a complex coacervate formed of at least one protein and at least one polysaccharide. Such core-shell capsules have proved suitable for benefit agent encapsulation and are described, for instance in WO 1996/020612 A1, WO 2001/03825 A1 or WO 2015/150370 A1.

Cross-linking of at least one protein with a first cross-linking agent followed by the addition of at least one polysaccharide to form a complex coacervate is described in WO 2021/239742 A1.

In one embodiment, the shell of the microcapsules is as described in WO 2023/020883 A1 or WO2023/170102A1.

In one embodiment, the shell of the microcapsules can be made of a biodegradable material or a non-biodegradable material. In one embodiment, the microcapsules are made of a biodegradable material.

In preferred embodiments of the present invention, the volume median diameter Dv(50) of the plurality of core-shell microcapsules is from 1 to 100 μm, preferably 5 to 75 μm, more preferably 8 to 60 μm, even more preferably 10 to 30 μm. Microcapsules having volume median diameter in the range from 10 to 30 μm show optimal deposition on various substrates, such as fabrics and hair.

The resultant encapsulated composition, presented in the form of a slurry of microcapsules suspended in an aqueous suspending medium, may be incorporated as such in a consumer product base. If desired, however, the slurry may be dried to present the encapsulated composition in dry powder form. Drying of a slurry of microcapsules is conventional, and may be carried out according techniques known in the art, such as spray-drying, evaporation, lyophilization or use of a desiccant. Typically, as is conventional in the art, dried microcapsules will be dispersed or suspended in a suitable powder, such as powdered silica, which can act as a bulking agent or flow aid. Such suitable powder may be added to the encapsulated composition before, during or after the drying step.

In particular, the drying process may be accompanied by an additional encapsulation process, wherein an additional functional material is entrapped in an additional encapsulating material.

For example, the slurry to be dried may comprise, additionally to the core-shell microcapsules obtained in the process according to the present invention, at least one non-encapsulated functional material and at least one water-soluble encapsulating material, so that the functional material, that is not encapsulated in the core-shell microcapsule, is entrapped in the water-soluble encapsulating material during drying. Typically, the at least one water-soluble encapsulating material comprises at least one hydrocolloid, such as starch octenyl succinate and gum acacia. The hydrocolloid promotes and stabilizes the dispersion of the non-encapsulated material in the aqueous phase of the slurry, so that, upon drying, a matrix is formed around or coexisting with the core-shell microcapsules.

The functional material that is encapsulated in the core-shell microcapsules may comprise a first fragrance, whereas the functional material entrapped in the water-soluble encapsulating material may comprise a second fragrance, wherein the first and second fragrances are identical or different.

Combining at least two encapsulation processes has the advantage of providing different mechanisms for releasing the functional material, for example a combination of moisture-induced and mechanical stress-induced releases.

The drying step may also be accompanied or followed by mechanical or thermal treatment, such as spheronization, granulation and extrusion.

In a microcapsule composition according to the present invention, the proportion of the benefit agent can be between about 10 to about 50 wt.-%, preferably between about 20 to about 47.5 wt.-%, even more preferably between about 30 to about 45 wt.-%, relative to the total weight of the microcapsule composition.

The proportion of the microcapsule composition as described herein above in the concentrated fabric softening composition may be between about 0 wt.-% to about 6 wt.-%, preferably about 4.4 wt.-% relative to the total weight of the concentrated fabric softening composition.

### Benefit Agent

The benefit agent comprised in the core can be a fragrance ingredient, a malodor counteractant or a mixture thereof.

In particular embodiments of the present invention, the core comprises at least one fragrance ingredient. A comprehensive list of fragrance ingredients that may be encapsulated in accordance with the present invention may be found in the perfumery literature, for example “Perfume & Flavor Chemicals”, S. Arctander (Allured Publishing, 1994). Encapsulated perfumes according to the present invention preferably comprise fragrance ingredients selected from the group consisting of ACETYL ISOEUGENOL ((E)-2-methoxy-4-(prop-1-en-1-yl)phenyl acetate); ADOXAL (2,6,10-trimethylundec-9-enal); AGRUMEX (2-(tert-butyl)cyclohexyl acetate); ALDEHYDE C 10 DECYLIC (decanal); ALDEHYDE C 11 MOA (2-methyldecanal); ALDEHYDE C 11 UNDECYLENIC (undec-10-enal); ALDEHYDE C 110 UNDECYLIC (undecanal); ALDEHYDE C 12 LAURIC (dodecanal); ALDEHYDE C 12 MNA PURE (2-methylundecanal); ALDEHYDE C 8 OCTYLIC (octanal); ALDEHYDE C 9 ISONONYLIC (3,5,5-trimethylhexanal); ALDEHYDE C 9 NONYLIC FOOD GRADE (nonanal); ALDEHYDE C 90 NONENYLIC ((E)-non-2-enal); ALDEHYDE ISO C 11 ((E)-undec-9-enal); ALDEHYDE MANDARINE ((E)-dodec-2-enal); ALLYL AMYL GLYCOLATE (prop-2-enyl 2-(3-methylbutoxy)acetate); ALLYL CAPROATE (prop-2-enyl hexanoate); ALLYL CYCLOHEXYL PROPIONATE (prop-2-enyl 3-cyclohexylpropanoate); ALLYL OENANTHATE (prop-2-enyl heptanoate); AMBER CORE1-((2-(tert-butyl)cyclohexyl)oxy) butan-2-olAMBERKETAL (3,8,8,11a-tetramethyldodecahydro-1H-3,5a-epoxynaphtho[2,1-c]oxepine); AMBERMAX (1,3,4,5,6,7-hexahydro-.beta., 1,1,5,5-pentamethyl-2H-2,4a-Methanonaphthalene-8-ethanol); AMBRETTOLIDE ((Z)-oxacycloheptadec-10-en-2-one); AMBROFIX ((3aR,5aS,9aS,9bR)-3a,6,6,9a-tetramethyl-2,4,5,5a,7,8,9,9b-octahydro-1H-benzo[e][1]benzofuran); AMYL BUTYRATE (pentyl butanoate); AMYL CINNAMIC ALDEHYDE ((Z)-2-benzylideneheptanal); AMYL SALICYLATE (pentyl 2-hydroxybenzoate); ANETHOLE SYNTHETIC ((E)-1-methoxy-4-(prop-1-en-1-yl)benzene); ANISYL ACETATE (4-methoxybenzyl acetate); APHERMATE (1-(3,3-dimethylcyclohexyl)ethyl formate); AUBEPINE PARA CRESOL (4-methoxybenzaldehyde); AURANTIOL ((E)-methyl 2-((7-hydroxy-3,7-dimethyloctylidene)amino)benzoate); BELAMBRE ((1R,2S,4R)-2′-isopropyl-1,7,7-trimethylspiro[bicyclo[2.2.1]heptane-2,4′-[1,3]dioxane]); BENZALDEHYDE (benzaldehyde); BENZYL ACETATE (benzyl acetate); BENZYL ACETONE (4-phenylbutan-2-one); BENZYL BENZOATE (benzyl benzoate); BENZYL SALICYLATE (benzyl 2-hydroxybenzoate); BERRYFLOR (ethyl 6-acetoxyhexanoate); BICYCLO NONALACTONE (octahydro-2H-chromen-2-one); BOISAMBRENE FORTE ((ethoxymethoxy)cyclododecane); BOISIRIS ((1S,2R,5R)-2-ethoxy-2,6,6-trimethyl-9-methylenebicyclo[3.3.1]nonane); BORNEOL CRYSTALS ((1S,2S,4S)-1,7,7-trimethylbicyclo[2.2.1]heptan-2-ol); BORNYL ACETATE ((2S,4S)-1,7,7-trimethylbicyclo[2.2.1]heptan-2-yl acetate); BOURGEONAL (3-(4-(tert-butyl)phenyl) propanal); BUTYL BUTYRO LACTATE (1-butoxy-1-oxopropan-2-yl butanoate); BUTYL CYCLOHEXYL ACETATE PARA (4-(tert-butyl)cyclohexyl acetate); BUTYL QUINOLINE SECONDARY (2-(2-methylpropyl) quinoline); CAMPHOR SYNTHETIC ((1S,4S)-1,7,7-trimethylbicyclo[2.2.1]heptan-2-one); CARVACROL (5-isopropyl-2-methylphenol); CARVONE LAEVO ((5R)-2-methyl-5-prop-1-en-2-ylcyclohex-2-en-1-one); CASHMERAN (1,1,2,3,3-pentamethyl-2,3,6,7-tetrahydro-1H-inden-4 (5H)-one); CASSYRANE (5-tert-butyl-2-methyl-5-propyl-2H-furan); CEDRENE ((1S,8aR)-1,4,4,6-tetramethyl-2,3,3a,4,5,8-hexahydro-1H-5,8a-methanoazulene); CEDRYL ACETATE ((1S,6R,8aR)-1,4,4,6-tetramethyloctahydro-1H-5,8a-methanoazulen-6-yl acetate); CEDRYL METHYL ETHER ((1R,6S,8aS)-6-methoxy-1,4,4,6-tetramethyloctahydro-1H-5,8a-methanoazulene); CETONE V ((E)-1-(2,6,6-trimethylcyclohex-2-en-1-yl) hepta-1,6-dien-3-one); CINNAMIC ALCOHOL SYNTHETIC ((E)-3-phenylprop-2-en-1-ol); CINNAMIC ALDEHYDE ((2E)-3-phenylprop-2-enal); CINNAMYL ACETATE ((E)-3-phenylprop-2-en-1-yl acetate); CIS JASMONE ((Z)-3-methyl-2-(pent-2-en-1-yl)cyclopent-2-enone); CIS-3-HEXENOL ((Z)-hex-3-en-1-ol); CITRAL TECH ((E)-3,7-dimethylocta-2,6-dienal); CITRATHAL R ((Z)-1,1-diethoxy-3,7-dimethylocta-2,6-diene); CITRONELLAL (3,7-dimethyloct-6-enal); CITRONELLOL EXTRA (3,7-dimethyloct-6-en-1-ol); CITRONELLYL ACETATE (3,7-dimethyloct-6-en-1-yl acetate); CITRONELLYL FORMATE (3,7-dimethyloct-6-en-1-yl formate); CITRONELLYL NITRILE (3,7-dimethyloct-6-enenitrile); CLONAL (dodecanenitrile); CORANOL (4-cyclohexyl-2-methylbutan-2-ol); COSMONE ((Z)-3-methylcyclotetradec-5-enone); COUMARIN PURE CRYSTALS (2H-chromen-2-one); CRESYL ACETATE PARA ((4-methylphenyl)acetate); CRESYL METHYL ETHER PARA (1-methoxy-4-methylbenzene); CUMIN NITRILE (4-isopropylbenzonitrile); CYCLAL C (2,4-dimethylcyclohex-3-ene-1-carbaldehyde); CYCLAMEN ALDEHYDE EXTRA (3-(4-isopropylphenyl)-2-methylpropanal); CYCLOGALBANATE (allyl 2-(cyclohexyloxy)acetate); CYCLOHEXYL ETHYL ACETATE (2-cyclohexylethyl acetate); CYCLOHEXYL SALICYLATE (cyclohexyl 2-hydroxybenzoate); CYCLOMYRAL (8,8-dimethyl-1,2,3,4,5,6,7,8-octahydronaphthalene-2-carbaldehyde); CYMENE PARA (1-methyl-4-propan-2-ylbenzene); DAMASCENONE ((E)-1-(2,6,6-trimethylcyclohexa-1,3-dien-1-yl)but-2-en-1-one); DAMASCONE ALPHA ((E)-1-(2,6,6-trimethylcyclohex-2-en-1-yl)but-2-en-1-one); DAMASCONE DELTA (1-(2,6,6-trimethyl-1-cyclohex-3-enyl)but-2-en-1-one); DECALACTONE GAMMA (5-hexyloxolan-2-one); DECENAL-4-TRANS ((E)-dec-4-enal); DELPHONE (2-pentylcyclopentanone); DELTA-3 CARENE ((1S,6S)-3,7,7-trimethylbicyclo[4.1.0]hept-3-ene); DIHEXYL FUMARATE (dihexyl-but-2-enedioate); DIHYDRO ANETHOLE (1-methoxy-4-propylbenzene); DIHYDRO JASMONE (3-methyl-2-pentylcyclopent-2-enone); DIHYDRO MYRCENOL (2,6-dimethyloct-7-en-2-ol); DIMETHYL ANTHRANILATE (methyl 2-(methylamino)benzoate); DIMETHYL BENZYL CARBINOL (2-methyl-1-phenylpropan-2-ol); DIMETHYL BENZYL CARBINYL ACETATE (2-methyl-1-phenylpropan-2-yl acetate); DIMETHYL BENZYL CARBINYL BUTYRATE (2-methyl-1-phenylpropan-2-yl butanoate); DIMETHYL OCTENONE (4,7-dimethyloct-6-en-3-one); DIMETOL (2,6-dimethylheptan-2-ol); DIPENTENE (1-methyl-4-(prop-1-en-2-yl)cyclohex-1-ene); DIPHENYL OXIDE (oxydibenzene); DODECALACTONE DELTA (6-heptyltetrahydro-2H-pyran-2-one); DODECALACTONE GAMMA (5-octyloxolan-2-one); DODECENAL ((E)-dodec-2-enal); DUPICAL ((E)-4-((3aS,7aS)-hexahydro-1H-4,7-methanoinden-5 (6H)-ylidene)butanal); EBANOL ((E)-3-methyl-5-(2,2,3-trimethylcyclopent-3-en-1-yl)pent-4-en-2-ol); ESTERLY (ethyl cyclohexyl carboxylate); ETHYL ACETATE (ethyl acetate); ETHYL ACETOACETATE (ethyl 3-oxobutanoate); ETHYL CINNAMATE (ethyl 3-phenylprop-2-enoate); ETHYL HEXANOATE (ethyl hexanoate); ETHYL LINALOOL ((E)-3,7-dimethylnona-1,6-dien-3-ol); ETHYL LINALYL ACETATE ((Z)-3,7-dimethylnona-1,6-dien-3-yl acetate); ETHYL MALTOL (2-ethyl-3-hydroxy-4H-pyran-4-one); ETHYL METHYL-2-BUTYRATE (ethyl 2-methylbutanoate); ETHYL OCTANOATE (ethyl octanoate); ETHYL OENANTHATE (ethyl heptanoate); ETHYL PHENYL GLYCIDATE (ethyl 3-phenyloxirane-2-carboxylate); ETHYL SAFRANATE (ethyl 2,6,6-trimethylcyclohexa-1,3-diene-1-carboxylate); ETHYL VANILLIN (3-ethoxy-4-hydroxybenzaldehyde); ETHYLENE BRASSYLATE (1,4-dioxacycloheptadecane-5,17-dione); EUCALYPTOL ((1s,4s)-1,3,3-trimethyl-2-oxabicyclo[2.2.2]octane); EUGENOL (4-allyl-2-methoxyphenol); EVERNYL (methyl 2,4-dihydroxy-3,6-dimethylbenzoate); FENCHYL ACETATE ((2S)-1,3,3-trimethylbicyclo[2.2.1]heptan-2-yl acetate); FENCHYL ALCOHOL ((1S,2R,4R)-1,3,3-trimethylbicyclo[2.2.1]heptan-2-ol); FENNALDEHYDE (3-(4-methoxyphenyl)-2-methylpropanal); FIXAMBRENE (3a,6,6,9a-tetramethyldodecahydronaphtho[2,1-b]furan); FIXOLIDE (1-(3,5,5,6,8,8-hexamethyl-5,6,7,8-tetrahydronaphthalen-2-yl) ethanone); FLORALOZONE (3-(4-ethylphenyl)-2,2-dimethylpropanal); FLORHYDRAL (3-(3-isopropylphenyl)butanal); FLORIDILE ((E)-undec-9-enenitrile); FLOROCYCLENE ((3aR,6S,7aS)-3a,4,5,6,7,7a-hexahydro-1H-4,7-methanoinden-6-yl propanoate); FLOROPAL (2,4,6-trimethyl-4-phenyl-1,3-dioxane); FLOROSA HC (tetrahydro-4-methyl-2-(2-methylpropyl)-2H-pyran-4-ol); FRESKOMENTHE (2-(sec-butyl)cyclohexanone); FRUCTONE (ethyl 2-(2-methyl-1,3-dioxolan-2-yl)acetate); FRUITATE ((3aS,4S,7R,7aS)-ethyl octahydro-1H-4,7-methanoindene-3a-carboxylate); FRUTONILE (2-methyldecanenitrile); GALBANONE PURE (1-(5,5-dimethylcyclohex-1-en-1-yl)pent-4-en-1-one); GARDENOL (1-phenylethyl acetate); GARDOCYCLENE ((3aR,6S,7aS)-3a,4,5,6,7,7a-hexahydro-1H-4,7-methanoinden-6-yl 2-methyl propanoate); GERANIOL ((E)-3,7-dimethylocta-2,6-dien-1-ol); GERANYL ACETATE ((E)-3,7-dimethylocta-2,6-dien-1-yl acetate); GERANYL CROTONATE ((E)-3,7-dimethylocta-2,6-dien-1-yl but-2-enoate); GERANYL ISOBUTYRATE ((E)-3,7-dimethylocta-2,6-dien-1-yl 2-methylpropanoate); GIVESCONE (ethyl 2-ethyl-6,6-dimethylcyclohex-2-enecarboxylate); HABANOLIDE ((E)-oxacyclohexadec-12-en-2-one); HEDIONE (methyl 3-oxo-2-pentylcyclopentaneacetate); HELIOTROPINE CRYSTALS (benzo[d][1,3]dioxole-5-carbaldehyde); HERBANATE ((2S)-ethyl 3-isopropylbicyclo[2.2.1]hept-5-ene-2-carboxylate); HEXENAL-2-TRANS ((E)-hex-2-enal); HEXENOL-3-CIS ((Z)-hex-3-en-1-ol); HEXENYL-3-CIS ACETATE ((Z)-hex-3-en-1-yl acetate); HEXENYL-3-CIS BUTYRATE ((Z)-hex-3-en-1-yl butanoate); HEXENYL-3-CIS ISOBUTYRATE ((Z)-hex-3-en-1-yl 2-methylpropanoate); HEXENYL-3-CIS SALICYLATE ((Z)-hex-3-en-1-yl 2-hydroxybenzoate); HEXYL ACETATE (hexyl acetate); HEXYL BENZOATE (hexyl benzoate); HEXYL BUTYRATE (hexyl butanoate); HEXYL CINNAMIC ALDEHYDE ((E)-2-benzylideneoctanal); HEXYL ISOBUTYRATE (hexyl 2-methylpropanoate); HEXYL SALICYLATE (hexyl 2-hydroxybenzoate); HYDROXYCITRONELLAL (7-hydroxy-3,7-dimethyloctanal); INDOFLOR (4,4a,5,9b-tetrahydroindeno[1,2-d][1,3]dioxine); INDOLE PURE (1H-indole); INDOLENE (8,8-di(1H-indol-3-yl)-2,6-dimethyloctan-2-ol); IONONE BETA ((E)-4-(2,6,6-trimethylcyclohex-1-en-1-yl)but-3-en-2-one); IRISANTHEME ((E)-3-methyl-4-(2,6,6-trimethylcyclohex-2-en-1-yl)but-3-en-2-one); IRISONE ALPHA ((E)-4-(2,6,6-trimethylcyclohex-2-en-1-yl)but-3-en-2-one); IRONE ALPHA ((E)-4-(2,5,6,6-tetramethylcyclohex-2-en-1-yl)but-3-en-2-one); ISO E SUPER (1-(2,3,8,8-tetramethyl-1,2,3,4,5,6,7,8-octahydronaphthalen-2-yl) ethanone); ISOAMYL ACETATE (3-methylbutyl acetate); ISOAMYL BUTYRATE (3-methylbutyl butanoate); ISOBUTYL METHOXY PYRAZINE (2-methylpropyl 3-methoxypyrazine); ISOCYCLOCITRAL (2,4,6-trimethylcyclohex-3-enecarbaldehyde); ISOEUGENOL ((E)-2-methoxy-4-(prop-1-en-1-yl) phenol); ISOJASMONE B 11 (2-hexylcyclopent-2-en-1-one); ISOMENTHONE DL (2-isopropyl-5-methylcyclohexanone); ISONONYL ACETATE (3,5,5-trimethylhexyl acetate); ISOPROPYL METHYL-2-BUTYRATE (isopropyl 2-methylbutanoate); ISOPROPYL QUINOLINE (6-isopropylquinoline); ISORALDEINE ((E)-3-methyl-4-(2,6,6-trimethylcyclohex-2-en-1-yl)but-3-en-2-one); JASMACYCLENE ((3aR,6S,7aS)-3a,4,5,6,7,7a-hexahydro-1H-4,7-methanoinden-6-yl acetate); JASMONE CIS ((Z)-3-methyl-2-(pent-2-en-1-yl)cyclopent-2-enone); JASMONYL (3-butyl-5-methyltetrahydro-2H-pyran-4-yl acetate); JASMOPYRANE FORTE (3-pentyltetrahydro-2H-pyran-4-yl acetate); JAVANOL ((1-methyl-2-((1,2,2-trimethylbicyclo[3.1.0]hexan-3-yl)methyl)cyclopropyl)methanol); KOAVONE ((Z)-3,4,5,6,6-pentamethylhept-3-en-2-one); LAITONE (8-isopropyl-1-oxaspiro[4.5]decan-2-one); LEAF ACETAL ((Z)-1-(1-ethoxyethoxy) hex-3-ene); LEMONILE ((2E,6Z)-3,7-dimethylnona-2,6-dienenitrile); LIFFAROME ((Z)-hex-3-en-1-yl methyl carbonate); LILIAL (3-(4-(tert-butyl)phenyl)-2-methylpropanal); LINALOOL (3,7-dimethylocta-1,6-dien-3-ol); LINALOOL OXIDE (2-(5-methyl-5-vinyltetrahydrofuran-2-yl) propan-2-ol); LINALYL ACETATE (3,7-dimethylocta-1,6-dien-3-yl acetate); MAHONIAL ((4E)-9-hydroxy-5,9-dimethyl-4-decenal); MALTOL (3-hydroxy-2-methyl-4H-pyran-4-one); MALTYL ISOBUTYRATE (2-methyl-4-oxo-4H-pyran-3-yl 2-methylpropanoate); MANZANATE (ethyl 2-methylpentanoate); MAYOL ((4-isopropylcyclohexyl)methanol); MEFROSOL (3-methyl-5-phenylpentan-1-ol); MELONAL (2,6-dimethylhept-5-enal); MERCAPTO-8-METHANE-3-ONE (mercapto-para-menthan-3-one); METHYL ANTHRANILATE (methyl 2-aminobenzoate); METHYL BENZOATE (methyl benzoate); METHYL CEDRYL KETONE (1-((1S,8aS)-1,4,4,6-tetramethyl-2,3,3a,4,5,8-hexahydro-1H-5,8a-methanoazulen-7-yl) ethanone); METHYL CINNAMATE (methyl 3-phenylprop-2-enoate); METHYL DIANTILIS (2-ethoxy-4-(methoxymethyl) phenol); METHYL DIHYDRO ISOJASMONATE (methyl 2-hexyl-3-oxocyclopentane-1-carboxylate); METHYL HEPTENONE PURE (6-methylhept-5-en-2-one); METHYL LAITONE (8-methyl-1-oxaspiro[4.5]decan-2-one); METHYL NONYL KETONE (undecan-2-one); METHYL OCTYNE CARBONATE (methyl non-2-ynoate); METHYL PAMPLEMOUSSE (6,6-dimethoxy-2,5,5-trimethylhex-2-ene); METHYL SALICYLATE (methyl 2-hydroxybenzoate); MUSCENONE ((Z)-3-methylcyclopentadec-5-enone); MYRALDENE (4-(4-methylpent-3-en-1-yl)cyclohex-3-enecarbaldehyde); MYRCENE (7-methyl-3-methyleneocta-1,6-diene); MYSTIKAL (2-methylundecanoic acid); NECTARYL (2-(2-(4-methylcyclohex-3-en-1-yl)propyl)cyclopentanone); NEOBERGAMATE FORTE (2-methyl-6-methyleneoct-7-en-2-yl acetate); NEOCASPIRENE EXTRA (10-isopropyl-2,7-dimethyl-1-oxaspiro[4.5]deca-3,6-diene); NEOFOLIONE ((E)-methyl non-2-enoate); NEROLEX ((2Z)-3,7-dimethylocta-2,6-dien-1-ol); NEROLIDOL ((Z)-3,7,11-trimethyldodeca-1,6,10-trien-3-ol); NEROLIDYLE ((Z)-3,7,11-trimethyldodeca-1,6,10-trien-3-yl acetate); NEROLINE CRYSTALS (2-ethoxynaphthalene); NEROLIONE (1-(3-methylbenzofuran-2-yl) ethanone); NERYL ACETATE ((Z)-3,7-dimethylocta-2,6-dien-1-yl acetate); NIRVANOLIDE ((E)-13-methyloxacyclopentadec-10-en-2-one); NONADIENAL ((2E,6Z)-nona-2,6-dienal); NONADIENOL-2,6 ((2Z,6E)-2,6-nonadien-1-ol); NONADYL (6,8-dimethylnonan-2-ol); NONALACTONE GAMMA (5-pentyloxolan-2-one); NONENAL-6-CIS ((Z)-non-6-enal); NONENOL-6-CIS ((Z)-non-6-en-1-ol); NOPYL ACETATE (2-(6,6-dimethylbicyclo[3.1.1]hept-2-en-2-yl)ethyl acetate); NYMPHEAL (3-(4-(2-methylpropyl)-2-methylphenyl) propanal); OCTALACTONE DELTA (6-propyltetrahydro-2H-pyran-2-one); METHYL HEXYL KETONE (octan-2-one); ORANGER CRYSTALS (1-(2-naphtalenyl)-ethanone); ORIVONE (4-(tert-pentyl)cyclohexanone); PANDANOL ((2-methoxyethyl)benzene); PARA TERT BUTYL CYCLOHEXYL ACETATE (4-(tert-butyl)cyclohexyl acetate); PARADISAMIDE (2-ethyl-N-methyl-N-(m-tolyl) butanamide); PEACH PURE (5-heptyldihydrofuran-2 (3H)-one); PELARGENE (2-methyl-4-methylene-6-phenyltetrahydro-2H-pyran); PELARGOL (3,7-dimethyloctan-1-ol); PEONILE (2-cyclohexylidene-2-phenylacetonitrile); PETALIA (2-cyclohexylidene-2-(o-tolyl) acetonitrile); PHARAONE (2-cyclohexylhepta-1,6-dien-3-one); PHENOXY ETHYL ISOBUTYRATE (2-(phenoxy)ethyl 2-methylpropanoate); PHENYL ACETALDEHYDE (2-phenyl-ethanal); PHENYL ETHYL ACETATE (2-phenylethyl acetate); PHENYL ETHYL ALCOHOL (2-phenylethanol); PHENYL ETHYL ISOBUTYRATE (2-phenylethyl 2-methylpropanoate); PHENYL ETHYL PHENYL ACETATE (2-phenylethyl 2-phenylacetate); PHENYL PROPYL ALCOHOL (3-phenylpropan-1-ol); PINENE ALPHA (2,6,6-trimethylbicyclo[3.1.1]hept-2-ene); PINENE BETA (6,6-dimethyl-2-methylenebicyclo[3.1.1]heptane); PINOACETALDEHYDE (3-(6,6-dimethylbicyclo[3.1.1]hept-2-en-2-yl) propanal); PIVAROSE (2,2-dimethyl-2-pheylethyl propanoate); POMAROSE ((2E,5E)-5,6,7-trimethylocta-2,5-dien-4-one); POMELOL (2,4,7-Trimethyl-6-octen-1-ol); PRECYCLEMONE B (1-methyl-4-(4-methylpent-3-en-1-yl)cyclohex-3-enecarbaldehyde); PRENYL ACETATE (3-methylbut-2-en-1-yl acetate); PRUNOLIDE (5-pentyldihydrofuran-2 (3H)-one); RADJANOL SUPER ((E)-2-ethyl-4-(2,2,3-trimethylcyclopent-3-en-1-yl)but-2-en-1-ol); RASPBERRY KETONE (4-(4-hydroxyphenyl) butan-2-one); RHUBAFURAN (2,4-dimethyl-4-phenyltetrahydrofuran); ROSACETOL (2,2,2-trichloro-1-phenylethyl acetate); ROSALVA (dec-9-en-1-ol); ROSE OXIDE (4-methyl-2-(2-methylprop-1-en-1-yl)tetrahydro-2H-pyran); ROSE OXIDE CO (4-methyl-2-(2-methylprop-1-en-1-yl)tetrahydro-2H-pyran); ROSYFOLIA (1-methyl-2-(5-methylhex-4-en-2-yl)cyclopropylmethanol); ROSYRANE SUPER (4-methyl-2-phenyl-3,6-dihydro-2H-pyran); SAFRALEINE (2,3,3-trimethyl-1-indanone); SAFRANAL (2,6,6-trimethylcyclohexa-1,3-dienecarbaldehyde); SANDALORE EXTRA (3-methyl-5-(2,2,3-trimethylcyclopent-3-en-1-yl)pentan-2-ol); SCENTAURUS CLEAN (ethyl (Z)-2-acetyl-4-methyltridec-2-enoate); SCENTAURUS JUICY (4-(dodecylthio)-4-methylpentan-2-one); SERENOLIDE (2-(1-(3,3-dimethylcyclohexyl) ethoxy)-2-methylpropyl cyclopropanecarboxylate); SILVANONE SUPRA (cyclopentadecanone, hexadecanolide); SILVIAL (2-methyl-3-[4-(2-methylpropyl)phenyl]propanal); SPIROGALBANONE (1-(spiro[4.5]dec-6-en-7-yl)pent-4-en-1-one); STEMONE ((E)-5-methylheptan-3-one oxime); STYRALLYL ACETATE (1-phenylethyl acetate); SUPER MUGUET ((E)-6-ethyl-3-methyloct-6-en-1-ol); SYLKOLIDE ((E)-2-((3,5-dimethylhex-3-en-2-yl)oxy)-2-methylpropyl cyclopropanecarboxylate); TERPINENE ALPHA (1-methyl-4-propan-2-ylcyclohexa-1,3-diene); TERPINENE GAMMA (1-methyl-4-propan-2-ylcyclohexa-1,4-diene); TERPINEOL (2-(4-methylcyclohex-3-en-1-yl) propan-2-ol); TERPINEOL ALPHA (2-(4-methyl-1-cyclohex-3-enyl) propan-2-ol); TERPINEOL PURE (2-(4-methylcyclohex-3-en-1-yl) propan-2-ol); TERPINOLENE (1-methyl-4-(propan-2-ylidene)cyclohex-1-ene); TERPINYL ACETATE (2-(4-methyl-1-cyclohex-3-enyl) propan-2-yl acetate); TETRAHYDRO LINALOOL (3,7-dimethyloctan-3-ol); TETRAHYDRO MYRCENOL (2,6-dimethyloctan-2-ol); THIBETOLIDE (oxacyclohexadecan-2-one); THYMOL (2-isopropyl-5-methylphenol); TOSCANOL (1-(cyclopropylmethyl)-4-methoxybenzene); TRICYCLAL (2,4-dimethylcyclohex-3-enecarbaldehyde); TRIDECENE-2-NITRILE ((E)-tridec-2-enenitrile); TRIFERNAL (3-phenylbutanal); TROPIONAL (3-(benzo[d][1,3]dioxol-5-yl)-2-methylpropanal); TROPIONAL (3-(benzo[d][1,3]dioxol-5-yl)-2-methylpropanal); UNDECATRIENE ((3E,5Z)-undeca-1,3,5-triene); UNDECAVERTOL ((E)-4-methyldec-3-en-5-ol); VANILLIN (4-hydroxy-3-methoxybenzaldehyde); VELOUTONE (2,2,5-trimethyl-5-pentylcyclopentanone); VELVIONE ((Z)-cyclohexadec-5-enone); VIOLET NITRILE ((2E,6Z)-nona-2,6-dienenitrile); YARA YARA (2-methoxynaphtalene); ZINARINE (2-(2,4-dimethylcyclohexyl)pyridine; BOIS CEDRE ESS CHINE (cedar wood oil); EUCALYPTUS GLOBULUS ESS CHINA (eucalyptus oil); GALBANUM ESS (galbanum oil); GIROFLE FEUILLES ESS RECT MADAGASCAR (clove oil); LAVANDIN GROSSO OIL FRANCE ORPUR (lavandin oil); MANDARIN OIL WASHED COSMOS (mandarin oil); ORANGE TERPENES (orange terpenes); PATCHOULI ESS INDONESIE (patchouli oil); YLANG ECO ESSENCE (ylang oil); and combinations thereof. These fragrance ingredients are particularly suitable for obtaining stable and performing microcapsules, owing to their favorable lipophilicity and olfactive performance.

The microcapsule composition is typically obtained in the form of a dispersion of microcapsules in an aqueous medium, also referred to as a slurry. The level of microcapsules, also referred to as solid content of the slurry, is typically from 30 to 50 wt %, more particularly 35 to 45 wt % of the slurry.

### Biocidal-Active Substance

In one embodiment, the concentrated fabric softening composition comprises one or more biocidal-active substance. A biocidal-active substance is a chemical substance or mixture thereof intended to destroy, deter, render harmless, or exert a controlling effect on any harmful organism.

Suitable biocidal-active substance includes alcohols and polyols, such as ethanol, propanol, isopropanol, glycerol, sorbitol, more particularly diols, still more particularly 1,2-diols, such as 1,3-butylene glycol, 1,3-propylene glycol, and 1,2-alkyldiols having 2 to 7 carbon atoms; and mixtures thereof; formaldehyde releasers, such as formaldehyde, imidazolidinyl urea (CAS 39236-46-9), diazolidinyl urea (CAS 78491-02-8), DMDM Hydantoin (1,3-Bis(hydroxymethyl)-5,5-dimethylimidazolidine-2,4-dione, CAS6440-58-0), Bronopol (2-Brom-2-nitro-1,3-propandiol, (CAS 52-51-7); Bronidox (5-Bromo-5-nitro-1,3-dioxane, CAS 30007-47-7); nitrogen-containing compounds, such as Quaternium-15 (1-(3-Chloroallyl)-3,5,7-triaza-1-azoniaadamantane chloride, CAS 4080-31-3), benzalkonium chloride (CAS 8001-54-5), methanamine (CAS 100-97-0), caprylhydroxamic acid, 2-hydroxyethylenamine, sodium hydroxymethylglycinate; and more particularly isothiazolinones and alkaloids, such as caffeine, nicotinamide, N, N-diethylnicotinamide, and N, N-dimethylbenzamide; hydroxypyrones and hydroxylactones, such as dehydroacetic acid and glucono delta-lactone; hydroxy esters, such as lactic acid monoesters; phenols, phenolic derivatives and polyphenols, such as palmitoyl-epigallocatechin-3-gallate (ex-green tea extracts) and pyrogallol; carboxylic and hydroxy-carboxylic acids and their conjugate bases.

In one embodiment, the biocidal-active substance is a mixture of methylchloroisothiazolinone and methylisothiazolinone. In one embodiment, the ratio methylchloroisothiazolinone to methylisothiazolinone is 3:1. In one embodiment, the biocidal-active substance is a 3:1 mixture of methylchloroisothiazolinone to methylisothiazolinone sold under the tradename Nipaguard CG by Clariant.

In one embodiment, the one or more biocidal-active substance may be present in an amount of between about 0.5 wt % to 2 wt %, preferably 1.3 wt % of the concentrated fabric softening composition.

In one embodiment, the concentrated fabric softening composition comprises less than about 60 wt % water.

### Method

The compositions according to the invention may be prepared by any of the means known in the art.

In one embodiment, the method of manufacture comprises the steps of:
a) providing a mixture of silicone-based polymer, a C11-C15 isoparaffinic hydrocarbon or a mixture thereof; cross-linked copolymer of acrylamide and cationic vinyl addition monomer cross-linked with a difunctional vinyl addition monomer and, optionally a non-encapsulated fragrance ingredient;
b) adding to the mixture resulting from step a) a copolymer of acrylamide and cationic vinyl addition monomer;
c) optionally, adding to the mixture resulting from step b) a microcapsule composition comprising a polymer encapsulating a benefit agent;
d) optionally, adding to the mixture resulting from step c) one or more biocidal-active substance.

In a preferred method of manufacture of a concentrated fabric softening composition according to the invention, the method comprises the steps of:
a) Adding at least one non-encapsulated fragrance ingredient to an aqueous solution of a cross-linked copolymer of acrylamide and cationic vinyl addition monomer cross-linked with a difunctional vinyl addition monomer and silicone-based polymer, C11-C15 isoparaffinic hydrocarbon or mixture thereof, and homogenizing this mixture with a propeller;
b) Adding an aqueous solution of a copolymer of acrylamide and cationic vinyl addition monomer to the mixture obtained in step a) and homogenizing this new mixture under the same conditions as in step a), in order to obtain an emulsion;
c) Optionally adding a microcapsule composition to the emulsion obtained in step b), and homogenizing this new mixture under the same conditions; and
d) Adding a biocidal-active substance and turning off the propeller once the biocidal-active substance and, optionally, the microcapsule composition are homogeneously dispersed.

The silicone-based polymer, C11-C15 isoparaffinic hydrocarbon or mixture thereof; cross-linked copolymer of acrylamide and cationic vinyl addition monomer cross-linked with a difunctional vinyl addition monomer; copolymer of acrylamide and cationic vinyl addition monomer; non-encapsulated fragrance ingredient; microcapsule composition comprising a polymer encapsulating a benefit agent and biocidal-active substance are as described hereinabove.

### Use

The products of the invention are concentrated fabric softening composition intended to be diluted with water at ratio of up to about 45:1 (water:concentrated fabric softening composition), such as about 35 to 1, or about 32 to 1, or about 20 to 1 and thereafter stored and used.

The diluted compositions of the present invention may be used in the rinse cycle of a domestic laundry process.

The diluted composition is preferably used in the rinse cycle of a home textile laundering operation, where, it may be added directly to a washing machine, e.g. through a dispenser drawer or, for a top-loading washing machine, directly into the drum. The compositions may also be used in a domestic hand-washing laundry operation.

It is also possible, though less desirable, for the diluted compositions of the present invention to be used in industrial laundry operations, e.g. as a finishing agent for softening new clothes prior to sale to consumers.

The present invention is further illustrated by means of the following non-limiting examples:

### Example 1: Preparation of a Concentrated Fabric Softening Composition

In Examples 1.1, 1.2, and 1.4 to 1.8, known amounts (see Table 1) of the following ingredients were added in a 0.6 L container:
Flosoft FS 222 (ex SNF, Polymer I)
silicone-based polymer or a C11-C15 isoparaffinic hydrocarbon (silicone/paraffin)
Non-encapsulated fragrance oil (Givaudan, free oil).
   and homogenized at room temperature using a mechanical propeller operating at a stirring speed of 100 to 300 rpm in order to form an emulsion.

Flosoft LS 407 (ex SNF, Polymer II) was added to this emulsion under continued homogenization under same stirring speed for 15 minutes.

To the above mixtures, Nipaguard CG (ex Clariant, biocid) was added (where indicated) and the mixture further homogenized at room temperature under stirring (100-300 RPM) for 5 minutes.

In Example 1.2, an aminoplast microcapsule composition comprising an encapsulated fragrance oil prepared according to WO 2019/174978 A1 (encapsulated oil) was added after the addition of Flosoft LS 407 (ex SNF) and the mixture was further homogenized at room temperature under stirring for 5 minutes.

In Example 1.3, the silicone-based polymer or C11-C15 isoparaffinic hydrocarbon was replaced with increased amounts of Flosoft FS 222 (Polymer I) and Flosoft LS 407 (Polymer II).

Samples based on the composition of Example 1.2 but with different silicone-based polymers and/or C11-C15 isoparaffinic hydrocarbons were prepared in Examples 1.4 to 1.8. The above-mentioned compositions are shown in Table 1.

TABLE 1
Compositions 1.1 to 1.8 (wt %)

| | Composition | | | | | | | |
|---|---|---|---|---|---|---|---|---|
| Ingredient | 1.1 | 1.2 | 1.3* | 1.4 | 1.5 | 1.6 | 1.7 | 1.8 |
| Polymer I | 27.8 | 27.5 | 32.8 | 27.5 | 27.5 | 27.5 | 27.5 | 27.5 |
| Silicone/Paraffin | 13.7 | 13.7 | 0 | 13 | 13 | 13 | 13 | 26 |
| free oil | 13.2 | 8.8 | 8.8 | 8.8 | 8.8 | 8.8 | 8.8 | 8.8 |
| Polymer II | 44.0 | 44.0 | 52.6 | 43.3 | 43.3 | 43.3 | 43.3 | 30.3 |
| encapsulated oil | | 4.4 | 4.4 | 4.4 | 4.4 | 4.4 | 4.4 | 4.4 |
| Biocid | | 1.3 | 1.3 | 1.3 | 1.3 | 1.3 | 1.3 | 1.3 |

*comparative

The silicone-based polymers and/or C11-C15 isoparaffinic hydrocarbons employed in the above-mentioned Examples are shown in Table 2.

TABLE 2
Silicone-based polymer or C11-C15 isoparaffinic
hydrocarbon in compositions 1.1-1.8

| Example | Silicone/paraffin | Trade name |
|---|---|---|
| 1.1 | Dimethicone 1.5CS | Xiameter ™ PMX-200 |
| | | 1.5CS (ex Dow Chemicals) |
| 1.2 | Dimethicone 1.5CS | Xiameter ™ PMX-200 |
| | | 1.5CS (ex Dow Chemicals) |
| 1.3* | — | |
| 1.4 | Cyclopentasiloxane | XIAMETER ™ PMX-0245 |
| | | (ex Dow Chemicals) |
| 1.5 | Cyclopentasiloxane (10%) | XIAMETER ™ PMX-0245 |
| | and Amodimethicone | DOWSIL ™ 2-8566 |
| | (3.7%) | (both ex Dow Chemicals) |
| 1.6 | Dimethicone 2CS | Xiameter ™ PMX-200 |
| | | 2CS (ex Dow Chemicals) |
| 1.7 | Isoalkane | Isopar ™ L Fluid (ex |
| | | Exxon Mobil) |
| 1.8 | Isoalkane (13%) and | Isopar ™ L Fluid (ex |
| | Amodimethicone (13%) | Exxon Mobil) and |
| | | DOWSIL ™ FM-6620 |
| | | Emulsion (ex Dow Chemicals) |

*comparative

The composition of the non-encapsulated fragrance oil is given in Table 3.

TABLE 3
Composition of the non-encapsulated fragrance oil

| Fragrance ingredient | Wt % |
|---|---|
| 4,6,6,7,8,8-hexamethyl-1,3,4,6,7,8- | 7 |
| hexahydrocyclopenta[g]isochromene | |
| (E)-2-benzylideneoctanal | 11 |
| (3aR,6S,7aS)-3a,4,5,6,7,7a-hexahydro-1H-4,7-methanoinden-6-yl | 10 |
| propanoate | |
| benzyl 2-hydroxybenzoate | 10 |
| 2,6-dimethyloct-7-en-2-ol | 5 |
| 3-(4-(2-methylpropyl)-2-methylphenyl)propanal | 8 |
| 2-methylundecanal | 10 |
| 1-(2,3,8,8-tetramethyl-1,2,3,4,5,6,7,8-octahydronaphthalen-2- | 5 |
| yl)ethanone | |
| (E)-3,3-dimethyl-5-(2,2,3-trimethyl-3-cyclopenten-1-yl)-4-penten- | 4 |
| 2-ol | |
| 3-ethoxy-4-hydroxybenzaldehyde | 3 |
| 4-(tert-butyl)cyclohexyl acetate | 4 |
| benzyl acetate | 2 |
| 2-phenylethyl acetate | 4 |
| pentyl 2-hydroxybenzoate | 8 |
| 5-heptyldihydrofuran-2(3H)-one | 2 |
| 2-(1-(3,3-dimethylcyclohexyl)ethoxy)-2-methylpropyl | 2 |
| cyclopropanecarboxylate | |
| 1-(2,6,6-trimethyl-1-cyclohex-3-enyl)but-2-en-1-one | 2 |
| prop-2-enyl heptanoate | 3 |

The viscosities of concentrated samples 1.2 to 1.8, measured using a Brookfield RV DV apparatus, are shown in Table 4. The viscosity of compositions 1.2 and 1.4 to 1.8 were measured at 50 RPM, spindle SC4-28 at 25° C., whereas the viscosity of composition 1.3 (without silicone-based polymer or isoparaffin) was measured at 12 RPM, using a specific spindle 93 at 25° C. It is clear that the presence of the silicone-based polymer or isoparaffin is required in order to achieve acceptable viscosity in the range of 50 to 3000 cps.

TABLE 4
Viscosities of concentrated compositions 1.2-1.8

| Sample | Viscosity (cps) |
|---|---|
| 1.2 | 190 |
| 1.3 | 24667 |
| 1.4 | 740 |
| 1.5 | 1500 |
| 1.6 | 1280 |
| 1.7 | 200 |
| 1.8 | 2750 |

### Example 2: Diluted Fabric Softening Composition at Dilution 32:1

Compositions 1.2 to 1.8 were diluted with water in a 32:1 ratio (32 parts water to 1 part concentrated composition). The viscosities of these dilutions were measured using a Brookfield RV DV at 50 RPM, spindle SC4-28 at 25° C. (Table 5).

TABLE 5
Impact of the silicone-based polymer or C11-C15
isoparaffinic hydrocarbon on the viscosity of fabric
conditioning compositions at dilution 32:1

| Sample | Viscosity (cps) |
|---|---|
| 1.3* | 470 |
| 1.2 | 480 |
| 1.4 | 490 |
| 1.5 | n/a |
| 1.6 | 530 |
| 1.7 | 520 |
| 1.8 | 560 |

*comparative

As apparent from Table 5, all diluted fabric conditioners show viscosities in the desired range of viscosities, of about 200 cps to about 3000 cps. However, the diluted composition 1.3, despite having the viscosity in the acceptance range, had a lumpy appearance.

The overall performance of the diluted softeners at a dilution of 32:1 was assessed by measuring the overall preference of a panel of 20 panellists in a softness test. The protocol for measuring the softness was as follows:
numerical scale 0 to 10; 0=none/10=highest softness;
the result is shown as a % the number of points scored by each sample.

Two side-by-side evaluation tests were carried out (I and II), each comparing several compositions according to the invention with the sample not containing any silicone-based polymer or isoparaffin. These results are shown in Table 6.

TABLE 6
Comparison of the softness performance
of the diluted compositions (32:1)

Percentage of panellists preferring the sample

| Sample | Comparison I (%) | Comparison II (%) |
|---|---|---|
| 1.3* | 6.7 | 13.2 |
| 1.2 | 53.3 | |
| 1.4 | 26.7 | 17.3 |
| 1.5 | 13.3 | |
| 1.6 | | 20.3 |
| 1.7 | | 25.7 |
| 1.8 | | 19.8 |

These results show superior acceptance by the panellists of the compositions according to the invention compared to the composition not containing any silicone-based polymer or isoparaffin, which signals enhanced overall performance of such compositions.

### Example 3: Effect of Dilution on Performance of Diluted Aqueous Fabric Softeners

Composition 1.2 was diluted with water in various ratios. Composition 1.3 (comparative) was also diluted with water in a 32:1 ratio (Table 7). The viscosity of these dilutions was measured using a Brookfield RV DV at 50 RPM, spindle SC4-28 at 25° C. The overall performance of the fabric softeners was assessed by measuring the overall preference of panel of 20 panellists. The results are reported in Table 7.

TABLE 7
Impact of dilution on fabric softener
viscosity and overall performance

| | Dilution | | Percentage of panellists |
|---|---|---|---|
| Sample | with water | Viscosity (mPas) | preferring the sample |
| Example 1.2.1 | 1:20 | 1070 | 28.6 |
| Example 1.2.2 | 1:32 | 480 | 31.2 |
| Example 1.2.3 | 1:45 | 300 | 30.6 |
| Example 1.3.2* | 1:32 | 470 | 9.7 |

*comparative

As apparent from Table 7, the fabric softening (conditioning) composition according to the present invention can be diluted up to 45 times without losing its acceptance by panellists. All diluted compositions of Example 1.2 in Table 7 are stable and homogeneous, except for the composition derived from the comparison sample 1.3, which had a lumpy appearance.

1. A concentrated fabric softening composition, wherein the concentrated composition comprises
a) a silicone-based polymer, a C11-C15 isoparaffinic hydrocarbon or a mixture thereof;
b) a copolymer of acrylamide and cationic vinyl addition monomer; and
c) a cross-linked copolymer of acrylamide and cationic vinyl addition monomer cross-linked with a difunctional vinyl addition monomer.

2. The concentrated composition according to claim 1, wherein the silicone-based polymer is a polydimethylsiloxane, a cyclopentasiloxane, an aminofunctional polydimethylsiloxane or mixtures thereof.

3. The concentrated composition according to claim 1, wherein
i) the copolymer of acrylamide and cationic vinyl addition monomer is poly(diallyldimethylammonium chloride-co-acrylamide) copolymer; and
ii) the cross-linked copolymer of acrylamide and cationic vinyl addition monomer cross-linked with a difunctional vinyl addition monomer is poly(trimethylammonioethylmethacrylate chloride-co-acrylamide) copolymer.

4. The concentrated composition according to claim 1, wherein the cross-linked copolymer of acrylamide and cationic vinyl addition monomer cross-linked with a difunctional vinyl addition monomer is a copolymer resulting from copolymerization of 5 to 100 mol % of cationic vinyl addition monomer, from 0 to 95 mol % of acrylamide and from 50 to 1000 ppm of a difunctional vinyl addition monomer cross-linking agent.

5. The concentrated composition according to claim 1, wherein the difunctional vinyl addition monomer is a methylene bisacrylamide.

6. The concentrated composition according to claim 1, wherein the cross-linked copolymer of acrylamide and cationic vinyl addition monomer cross-linked with a difunctional vinyl addition monomer is a copolymer resulting from copolymerization of about 20 mol % acrylamide, about 80 mol % dimethyl amino ethyl methacrylate methyl chloride (MADAM methyl chloride) cross-linked with from 450 to 600 ppm of methylene bisacrylamide.

7. The concentrated composition according to claim 1, wherein the composition comprises between about 20 wt % and about 50 w % of softener actives.

8. The concentrated composition according to claim 1, wherein the composition comprises:
a) between about 5 wt % and about 30 wt % of a silicone-based polymer, a C11-C15 isoparaffinic hydrocarbon or a mixture thereof;
b) between about 1 wt % and about 10 wt % of a copolymer of acrylamide and diallyldimethylammonium chloride; and
c) between about 5 wt % and about 25 wt % of a cross-linked copolymer resulting from copolymerization of about 20 mol % acrylamide, about 80 mol % dimethyl amino ethyl methacrylate methyl chloride (MADAM methyl chloride) cross-linked with from 450 to 600 ppm of methylene bisacrylamide.

9. The concentrated composition according to claim 1, wherein the ratio between the copolymer of acrylamide and cationic vinyl addition monomer to the cross-linked copolymer of acrylamide and cationic vinyl addition monomer cross-linked with a difunctional vinyl addition monomer is between about 1:0.3 to about 1:1.8.

10. The concentrated composition according to claim 1 further comprising
at least one non-encapsulated fragrance ingredient.

11. The concentrated composition according to claim 15, wherein the shell of the microcapsule comprises a melamine-formaldehyde polymer, an urea-formaldehyde polymer, a polyurea or polyurethane polymer, a polyamide, a polyacrylate, a polycarbonate, a polymeric stabilizer that is formed by combination of a polymeric surfactant with at least one aminosilane, a complex coacervate formed by cross-linking of at least one protein with a first cross-linking agent and at least one polysaccharide, or a hydrated polymer and a polymeric stabilizer formed by reaction of an aminosilane with a polyfunctional isocyanate.

12. The concentrated composition according to claim 15, wherein the benefit agent is a fragrance ingredient, a malodor counteractant or a mixture thereof.

13. A method of making a concentrated composition according to claim 1, the method comprising the steps of
a) providing a mixture of silicone-based polymer, a C11-C15 isoparaffinic hydrocarbon or a mixture thereof; a cross-linked copolymer of acrylamide and cationic vinyl addition monomer cross-linked with a difunctional vinyl addition monomer and, optionally a non-encapsulated fragrance ingredient; and
b) adding to the mixture resulting from step a) a copolymer of acrylamide and cationic vinyl addition monomer.

14. A method of providing a stable dilute fabric softener composition, the method comprising mixing the concentrated composition of claim 1 with water in a ratio of 1 part concentrated composition to up to 45 parts water.

15. The concentrated composition according to claim 10 further comprising a microcapsule composition comprising a polymer encapsulating a benefit agent, wherein the benefit agent is encapsulated in core-shell microcapsules comprising a core and a shell surrounding the core.

16. The concentrated composition according to claim 10 further comprising one or more biocidal-active substance.

17. A method of making the concentrated composition according to claim 15, the method comprising the steps of
a) providing a mixture of silicone-based polymer, a C11-C15 isoparaffinic hydrocarbon or a mixture thereof; a cross-linked copolymer of acrylamide and cationic vinyl addition monomer cross-linked with a difunctional vinyl addition monomer and, optionally a non-encapsulated fragrance ingredient;
b) adding to the mixture resulting from step a) a copolymer of acrylamide and cationic vinyl addition monomer; and
c) adding to the mixture resulting from step b) a microcapsule composition comprising a polymer encapsulating a benefit agent.
